(19) United States
(12) Patent Application Publication
(10) Pub. No.: US 2025/0000249 A1
(43) Pub. Date: Jan. 2, 2025

(54) CLEANING EQUIPMENT

(71) Applicant: SHENZHEN SILVER STAR INTELLIGENT GROUP CO., LTD., Shenzhen (CN)

(72) Inventors: Yancheng He, Shenzhen (CN); Zhexin Gao, Shenzhen (CN); Chunzhong Wei, Shenzhen (CN); Xin Xu, Shenzhen (CN); Lirong Ye, Shenzhen (CN)

(21) Appl. No.: 18/786,669

(22) Filed: Jul. 29, 2024

Related U.S. Application Data
(63) Continuation of application No. PCT/CN2024/081974, filed on Mar. 15, 2024.

(30) Foreign Application Priority Data
Apr. 28, 2023 (CN) 202310493163.7

(51) Int. Cl. A46B 17/06; A46B 13/00; A46B 13/02; A47L 11/30; A47L 11/40; B08B 1/16; B08B 1/20

(52) U.S. Cl. CPC A46B 17/06; A46B 13/001; A46B 13/02; A47L 11/302; A47L 11/4041; A47L 11/4083; A47L 11/4088; B08B 1/165; B08B 1/20; A46B 2200/3033

(57) ABSTRACT

A cleaning equipment includes a housing, a rolling brush, a spraying device, a dirt storage container, and a baffle plate. A bottom portion of the housing defines a dirt suction cavity. The housing defines a dirt suction channel including a dirt inlet opening and a dirt outlet opening. The dirt inlet opening communicates with the dirt suction cavity. The dirt outlet opening communicates with the dirt storage container. The rolling brush is mounted in the dirt suction cavity and partially extends out of the dirt suction cavity. The spraying device is positioned in the dirt suction cavity. The spraying device and the dirt inlet opening are arranged at intervals in a rotational direction of the rolling brush. The baffle plate connects to a sidewall of the dirt suction cavity. The baffle plate is positioned between the spraying device and the dirt inlet opening in the rotational direction.

### CROSS-REFERENCE TO RELATED APPLICATIONS

The present disclosure is a continuation of International Application No. PCT/CN2024/081974, filed on Mar. 15, 2024, which claims priority of Chinese Patent Application No. 202310493163.7, filed on Apr. 28, 2023, titled “cleaning equipment”, the contents of which are incorporated herein by reference.

### TECHNICAL FIELD

The present disclosure relates to the technology field of cleaning equipment, and in particular, relates to a cleaning equipment.

### BACKGROUND

Cleaning equipment such as mopping robots, scrubber robots, handheld scrubbers, etc. are usually includes a rolling brush, a spraying device and a suction device. The spraying device is used to spray cleaning liquid to the rolling brush, the rolling brush is wet by the cleaning liquid, and then driven to rotate at high speed, in order to contact with the floor and rub the floor, and the suction device is used to drive the air flow to produce suction force, in order to suck the garbage and sewage into a dirt storage container when the rolling brush is cleaning the floor.

However, in a typical cleaning equipment, the spraying device and the rolling brush are in a common space, and the garbage brushed up by the rolling brush in cleaning the floor is easily thrown to the spraying device under the action of centrifugal force, which results in the spraying device being easily adhered by the garbage or even clogged by the garbage, and thus affects the normal use of the cleaning equipment.

### SUMMARY

An embodiment of the present disclosure provides a cleaning equipment. The cleaning equipment includes a housing, a rolling brush, a spraying device, a dirt storage container, and a first baffle plate. A bottom portion of the housing defines a dirt suction cavity. The housing defines a dirt suction channel. The dirt suction channel includes a dirt inlet opening and a dirt outlet opening. The dirt inlet opening is communicated with the dirt suction cavity, and the dirt outlet opening is communicated with the dirt storage container of the cleaning equipment. The rolling brush is rotatably mounted in the dirt suction cavity and partially extends out of the dirt suction cavity. The spraying device is positioned in the dirt suction cavity. The spraying device is configured to spray cleaning liquid to the rolling brush. The spraying device and the dirt inlet opening are arranged at intervals in a rotational direction of the rolling brush. The first baffle plate is connected to a sidewall of the dirt suction cavity. The first baffle plate and the rolling brush are arranged side by side. The first baffle plate is positioned between the spraying device and the dirt inlet opening in the rotational direction of the rolling brush. The first baffle plate is extending into the dirt suction cavity and configured to touch the rolling brush.

### BRIEF DESCRIPTION OF THE DRAWINGS

In order to more clearly illustrate the technical solutions in the embodiments of the present disclosure or prior art, the accompanying drawings to be used in the description of the embodiments or prior art will be briefly introduced below, and it will be obvious that the accompanying drawings in the following description are only some of the embodiments of the present disclosure, and that other drawings can be obtained according to the structures illustrated in the drawings by a person of ordinary skill in the field, without creative labor.

FIG. 1 is a cross-sectional view of a cleaning equipment according to an embodiment of the present disclosure;

FIG. 2 is another cross-sectional view of the cleaning equipment of FIG. 1;

FIG. 3 is a partial enlarged schematic view of part A of FIG. 2;

FIG. 4 is a cross-sectional view of a base, a rolling brush, and a spraying device of the cleaning equipment of FIG. 1;

FIG. 5 is a cross-sectional view of an upper cover of the cleaning equipment of FIG. 1;

FIG. 6 is a structural schematic view of the upper cover of the cleaning equipment of FIG. 1;

FIG. 7 is a partial enlarged schematic view of the cleaning equipment according to another embodiment of the present disclosure;

FIG. 8 is a partial enlarged schematic view of part B of FIG. 6; and

FIG. 9 is a partial enlarged schematic view of part C of FIG. 6.

### DETAILED DESCRIPTION

The technical solutions in the embodiments of the present disclosure will be clearly and completely described below in conjunction with the accompanying drawings in the embodiments of the present disclosure, and it is clear that the described embodiments are only a part of the embodiments of the present disclosure, and not all of the embodiments. Based on the embodiments in the present disclosure, all other embodiments obtained by a person of ordinary skill in the art without making creative labor fall within the protective scope of the present disclosure.

It should be noted that all directional indications in the embodiments of the present disclosure are only used to explain the relative positional relationship, movement and the like among the various components in a particular attitude, and if the particular attitude is changed, the directional indications are changed accordingly.

Furthermore, descriptions in the present disclosure involving “first”, “second”, and the like are used for descriptive purposes only, and are not to be construed as indicating or implying their relative importance or implicitly specifying the number of technical features. As a result, a feature defined as “first” or “second” may include at least one such feature, either explicitly or implicitly. In addition, the technical solutions between the various embodiments can be combined with each other, but it must be based on the fact that the person of ordinary skill in the art can realize it, and when the combination of technical solutions is contradictory or unattainable, it should be considered that the combination of such technical solutions does not exist and is not within the protective scope of the claims of the present disclosure.

The present disclosure provides a cleaning equipment. The cleaning equipment may be a self-moving mopping robot, a self-moving scrubber robot or a self-moving scrubbing and mopping integrated machine. The cleaning equipment may also be a hand-held mopping robot, a hand-held scrubber robot or a hand-held scrubbing and mopping integrated machine, and which is not specifically limited herein.

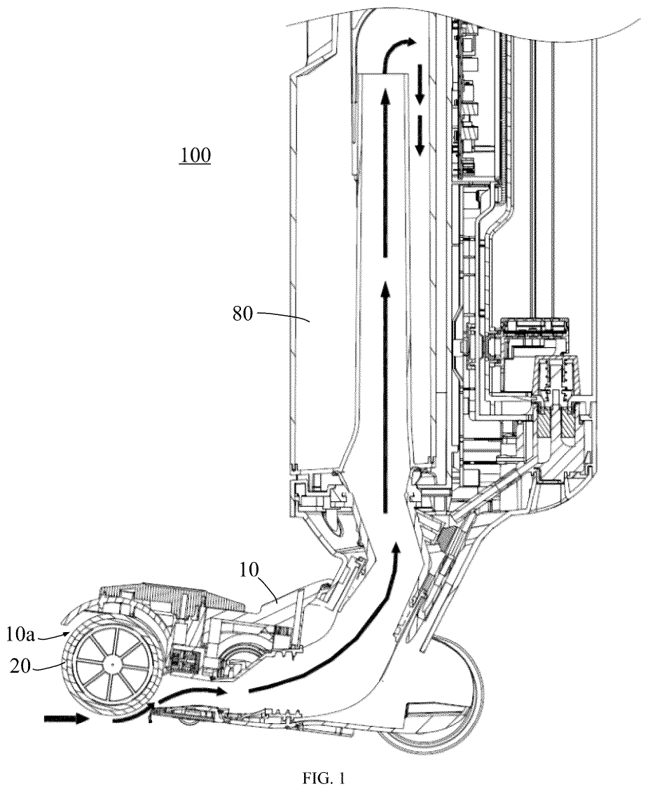

Referring to FIGS. 1, 2 and 3, the cleaning equipment 100 includes a housing 10, a rolling brush 20, and a spraying device 30. A bottom portion of the housing 10 is recessed to define a dirt suction cavity 10a. The housing 10 also defines a suction channel 10b. The dirt suction channel 10b includes a dirt inlet opening 10c and a dirt outlet opening 10d. The dirt inlet opening 10c is communicated with the dirt suction cavity 10a. The dirt outlet opening 10d is communicated with a sewage storage container 80 of the cleaning equipment 100. The dirt rolling brush 20 is rotatably mounted in the dirt suction cavity 10a and partially extends out of the dirt suction cavity 10a. The spraying device 30 is positioned in the dirt suction cavity 10a. The spraying device 30 is configured to spray cleaning liquid to the rolling brush 20. The spraying device 30 and the dirt inlet opening 10c are arranged at intervals in a the rotational direction of the rolling brush 20. A first baffle plate 40 is positioned in the dirt suction cavity 10a. The first baffle plate 40 is connected to a sidewall of the dirt suction cavity 10a. The first baffle plate 40 and the rolling brush 20 are arranged side by side. The first baffle plate 40 is positioned between the spraying device 30 and the dirt inlet opening 10c in the rotational direction of the rolling brush 20. The first baffle plate 40 is extending into the dirt suction cavity 10a and configured to touch the rolling brush 20.

The dirt suction cavity 10a may have a variety of shapes. The contour of the dirt suction cavity 10a may be a rectangular shape, the contour of the dirt suction cavity 10a may also be a cylindrical shape, the contour of the dirt suction cavity 10a may also be a regular polygonal shape, and the contour of the dirt suction cavity 10a may also be a heteromorphical shape, which are not enumerated herein. In some embodiments, the internal contour of the dirt suction cavity 10a is arranged in a cylindrical shape, on the one hand, it can be adapted to the shape of the rolling brush 20, and on the other hand, it is also convenient for the flow of the fluid.

It should be noted that the position of the dirt inlet opening 10c is related to the rotational direction of the rolling brush 20, when the rolling brush 20 is rotated with respect to the housing 10, the rolling brush 20 has a side that is rotated from the inside of the dirt suction cavity 10a to the outside of the dirt suction cavity 10a, the rolling brush 20 also has a side that is rotated from the outside of the dirt suction cavity 10a to the inside of the dirt suction cavity 10a, and the dirt inlet opening 10c is located on the side that the rolling brush 20 is rotated from the outside of the dirt suction cavity 10a to the inside of the dirt suction cavity 10a. The dirt outlet opening 10d is communicated with the dirt storage container 80 of the cleaning device 100. The dirt storage container 80 of the cleaning device 100 is pneumatically communicated with the suction device of the cleaning device 100, and the suction device of the cleaning device 100 operates to drive the air to flow, so as to form a negative pressure and generate suction force at the dirt inlet opening 10c.

The spraying device 30 is a liquid spraying structure, the spraying device 30 may be arranged independent from the housing 10, the spraying device 30 may be a shower head, a spraying nozzle and other structures, the connection between the spraying device 30 and the housing 10 is a variety of ways, such as screw connection, snap connection, welding and so on. The spraying device 30 and the housing 10 may also be integrally formed with each other, and the spraying device 30 may be formed by a hole structure or a pipe structure on the housing 10. The spraying device 30 may be directly communicated with a container containing cleaning liquid, and the spraying device 30 may also be communicated with the container containing the cleaning liquid through a pipeline, which is not specifically limited herein.

The first baffle plate 40 is fixedly connected to the sidewall of the dirt suction cavity 10a. There are various connecting ways between the first baffle plate 40 and the sidewall of the dirt suction cavity 10a. The first baffle plate 40 and the sidewall of the dirt suction cavity 10a may be connected by welding, screw connection, snap connection, and other ways, and there is no specific limitation herein. The first baffle plate 40 has a overall shape of elongated strip, but the shape of the cross-section of the first baffle plate 40 has various shapes, and the cross-section of the first baffle plate 40 may be in a rectangular, triangular, oval, and other shapes, and will not be specifically limited herein. The first baffle plate 40 may be made of a variety of materials, the first baffle plate 40 may be made of plastic material, metal material, wooden material, rubber material, and other materials, without specific limitation herein.

The spraying device 30 and the dirt inlet opening 10c are arranged at intervals in the rotational direction of the rolling brush 20. The first baffle plate 40 is located between the spraying device 30 and the dirt inlet opening 10c in the rotational direction of the rolling brush 20. When the rolling brush 20 is rotated from the outside of the dirt suction cavity 10a to the inside of the dirt suction cavity 10a, the rolling brush 20 first passes through the position where the dirt inlet opening 10c is located, then passes through the position where the first baffle plate 40 is located, and finally passes through the position where the spraying device 30 is located. As a result, the sewage brought up by the rotation of the rolling brush 20 can be blocked by the first baffle plate 40, and at the same time the garbage brought up by the rotation of the rolling brush 20 can also be blocked by the first baffle plate 40. In addition, the garbage attached to the rolling brush 20 can be scraped off by the first baffle plate 40, thereby avoiding the garbage brought up by the rolling brush 20 from being thrown to the spraying device 30 and blocking the spraying device 30, and it also enables the sewage and garbage brushed up by the rolling brush 20 to be sucked into the dirt suction channel 10b through the dirt inlet opening 10c as much as possible, thereby facilitating the improvement of the cleaning effect of the cleaning equipment 100.

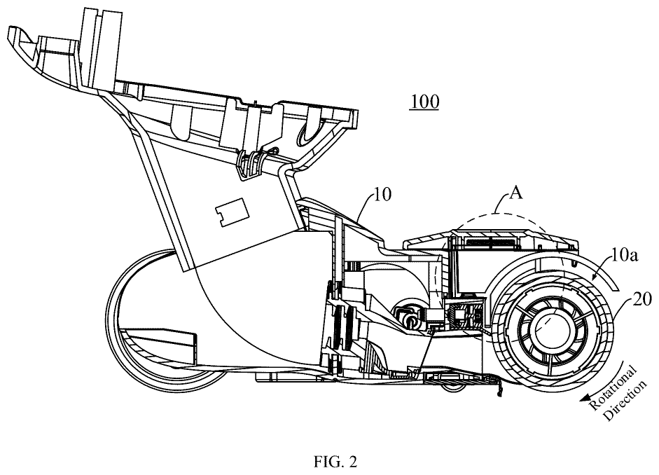

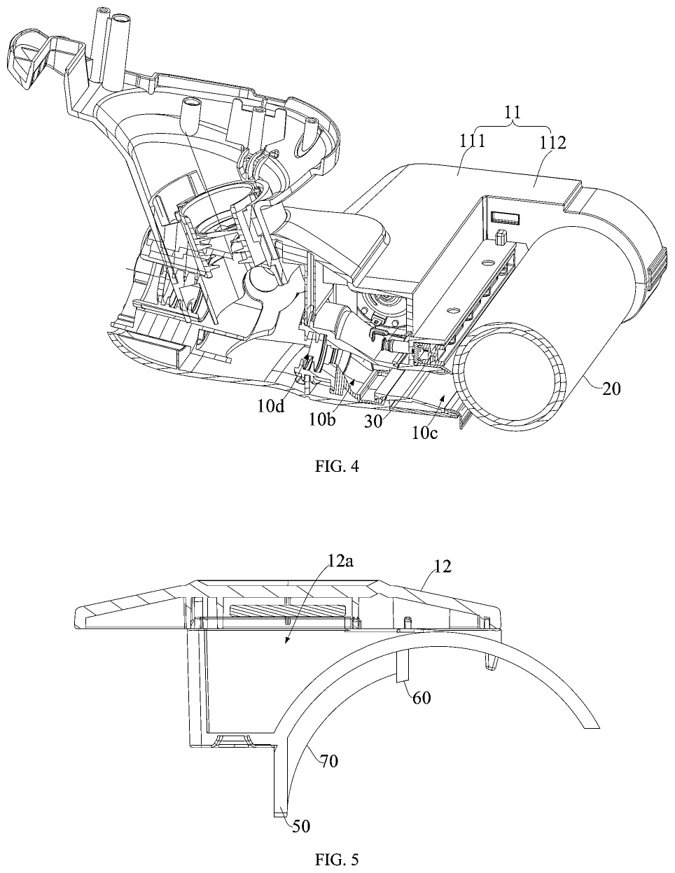

It should be noted that the housing 10 may include two parts, and the housing 10 may also include three or more parts, which will not be specifically limited herein. In some embodiments, referring to FIGS. 2 to 4, the housing 10 includes a base 11 and an upper cover 12, the base 11 includes a main body 111 and two connecting arms 112, the two connecting arms 112 are located on the same side of the main body 111 in a horizontal direction. An end of each of the two connecting arms 112 is connected to the main body 111. The two connecting arms 112 are extended in the horizontal direction and arranged spaced apart. A cross-section of the base 11 in the horizontal direction is roughly C-shaped, in other words, the main body 111 and the two connecting arms 112 cooperatively define a half-enclosed mounting space. The upper cover 12 may be connected to the main body 111 and/or the two connecting arms 112, and the upper cover 12 and the main body 111 as well as the two connecting arms 112 cooperatively define the dirt suction cavity 10a.

The rolling brush 20 is positioned between the two connecting arms 112. Two ends of the rolling brush 20 in an axial direction of the rolling brush 20 are rotatably connected to the two connecting arms 112 respectively. The rolling brush 20 is partially protruding from an opening of the dirt suction cavity 10a. The dirt suction channel 10b is defined in the main body 111. The dirt inlet opening 10c is located on the side of the main body 111 adjacent to the two connecting arms 112. Since the spraying device 30 only needs to be positioned in the dirt suction cavity 10a, the spraying device 30 can be connected with the main body 111 and/or the two connecting arms 112. Similarly, since the first baffle plate 40 only needs to be positioned in the dirt suction cavity 10a and located between the dirt inlet opening 10c and the spraying device 30 in the rotational direction of the rolling brush 20, the first baffle plate 40 may be positioned on the main body 111 and/or the upper cover 12.

It should be noted that the upper cover 12 may be fixedly connected to the base 11, and the connection between the upper cover 12 and the main body 111 and/or the two connecting arms 112 of the base 11 may be fixedly connected by means of screws, glue, and the like. The connection between the upper cover 12 and the base 11 may be a detachable connection, and the connection between the upper cover 12 and the main body 111 and/or the two connecting arms 112 of the base 11 may be a detachable connection by means of a snap connection, a screw connection and other means to realize the detachable connection. In this embodiment, the upper cover 12 and the base 11 are detachably connected to each other. Since the dirt suction cavity 10a is defined by the base 11 and the upper cover 12, the upper cover 12 and the base 11 are detachably connected to each other, thereby facilitating the cleaning of the sidewall of the dirt suction cavity 10a.

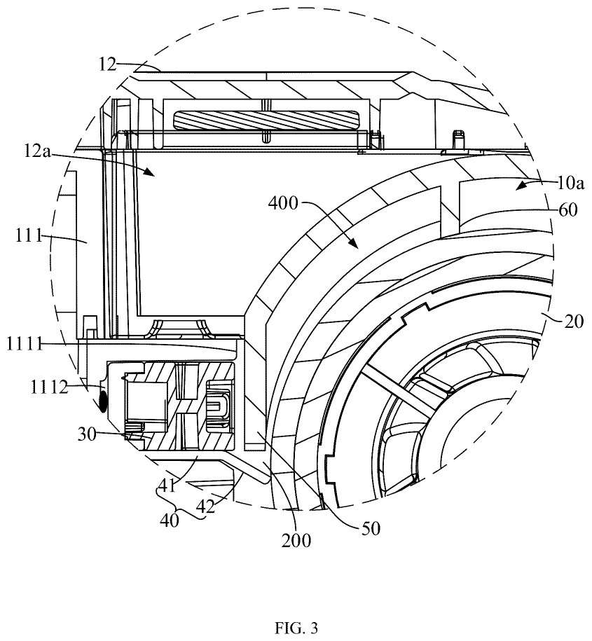

Based on the technical solution that the housing 10 includes two parts, i.e., the base 11 and the upper cover 12, in some embodiments, the spraying device 30 is positioned on the main body 111, specifically, referring to FIG. 3, the main body 111 includes a mounting wall 1111 facing the rolling brush 20. The mounting wall 1111 constitutes part of the sidewall of the dirt suction cavity 10a. The dirt inlet opening 10c is defined in the mounting wall 1111. The mounting wall 1111 also defines a mounting groove 1112. The mounting groove 1112 is located above the dirt inlet opening 10c. The spraying device 30 is mounted in the mounting groove 1112. Thus, the spraying device 30 can be hidden in a side of the sidewall of the dirt suction cavity 10a, thereby avoiding the spraying device 30 from protruding out of the sidewall of the dirt suction cavity 10a to touch the rolling brush 20, and thereby avoiding the spraying device 30 from being clogged by the rolling brush 20. In addition, by locating the spraying device 30 in a side of the sidewall of the dirt suction cavity 10a, the size of the dirt suction cavity 10a can also be reduced, which is conducive to making the housing 10 smaller.

It should be noted that, referring to FIG. 5, in some embodiments, the upper cover 12 defines a liquid storage cavity 12a, a sidewall of the mounting groove 1112 away from the dirt inlet opening 10c is concave to form a liquid inlet channel upwardly. The liquid inlet channel is communicated with the spraying device 30. The upper cover 12 defines a liquid outlet channel which is communicated with the liquid storage cavity 12a. When the upper cover 12 is assembled to the base 11, the liquid outlet channel of the upper cover 12 is communicated with the liquid inlet channel of the main body 111, which allows the cleaning liquid in the liquid storage cavity 12a to flow to the spraying device 30. Valves can be positioned on the liquid inlet channel and/or the liquid outlet channel, so as to conveniently control the supply of the cleaning liquid to the spraying device 30.

Further, the first baffle plate 40 includes a connecting portion 41 and a scraping portion 42 positioned sequentially along the extension direction of the two connecting arms 112. The connecting portion 41 extends into the mounting groove 1112, and the connecting portion 41 is positioned between the spraying device 30 and a sidewall of the mounting groove 1112 adjacent to the dirt inlet opening 10c, in other words, the connecting portion 41 is fixed by the clamping of the spraying device 30 and the sidewall of the mounting groove 1112 adjacent to the dirt inlet opening 10c. The scraping portion 42 is connected to the connection portion 41 and extends out of the mounting groove 1112, for touching a circumferential sidewall of the rolling brush 20.

By these means, on the one hand, the spraying device 30 and the first baffle plate 40 can be assembled in one assembly process, and on the other hand, the first baffle plate 40 is arranged adjacent to the spraying device 30, the rolling brush 20 can be effectively blocked from touching the spraying device 30, which ensures that the spraying device 30 is not affected by the rolling brush 20, and thus ensures that the spraying device 30 can keep spraying liquid smoothly at all times.

When the connecting portion 41 is clamped and fixed by the spraying device 30 and the sidewall of the mounting groove 1112 adjacent to the dirt inlet opening 10c, the connecting portion 41 may be made of a flexible material, for example, the connecting portion 41 is made of flexible plastic material, rubber, or silicone, and so on. Since the flexible material has a good deformation capability, when the spraying device 30 and the connection portion 41 are assembled together into the mounting groove 1112, the connection portion 41 can be deformed to fit the gap between the spraying device 30 and the sidewall of the mounting groove 1112 adjacent to the dirt inlet opening 10c, which reduces the precision requirement of the mounting groove 1112.

Further, the mounting wall 1111 is extending in an upward and downward direction. The two connecting arms 112 are both connected to the mounting wall 1111. The dirt inlet opening 10c and the mounting groove 1112 are both defined in the mounting wall 1111. The mounting groove 1112 is positioned over the dirt inlet opening 10c. The connecting portion 41 is extending in a horizontal direction, i.e., the connecting portion 41 extends in the extension direction of the two connecting arms 112. The scraping portion 42 is extending in the axial direction of the rolling brush 20 and is oblique with respect to the upward and downward direction. The position of the scraping portion 42 adjacent to the rolling brush 20 is lower than the position of the scraping portion 42 connected to the connecting portion 41.

Since the extension direction of the scraping portion 42 is facing the rotational direction of the rolling brush 20, this facilitates the rotation of the rolling brush 20 relative to the scraping portion 42, thereby facilitating the scraping portion 42 to scrape off the garbage on the rolling brush 20, and the garbage scraped off by the scraping portion 42 will fall downwards under the force of gravity and eventually enter into the dirt suction channel 10b through the dirt inlet opening 10c. Meanwhile, since the scraping portion 42 is oblique with respect to the upward and downward direction, the sewage and garbage brought up by the rolling brush 20 in an upward movement will be thrown to the side of the scraping portion 42 adjacent to the dirt inlet opening 10c and ultimately flow downwards, and the sewage and garbage on the rolling brush 20 will be scraped down and flow downwards by the scraping portion 42, which will cause both the sewage and the garbage to be sucked into the dirt suction channel 10b.

In addition, the cleaning liquid sprayed by the spraying device 30 flows along the scraping portion 42 toward the rolling brush 20, which makes the cleaning liquid flow downwards along the scraping portion 42 to the position where the scraping portion 42 is in contact with the rolling brush 20 at a certain downward flowing speed. When the downward flowing cleaning liquid is in contact with the rolling brush 20, it can be rinsed on the surface of the rolling brush 20, which facilitates flushing off all the garbage as well as the sewage on the surface of the rolling brush 20.

In addition, the cleaning liquid sprayed from the spraying device 30 flows along the scraping portion 42 toward the rolling brush 20, which causes the cleaning liquid to flow from top to down along the scraping portion 42 to a position where the scraping portion 42 touches the rolling brush 20 with a certain downward flow speed. When the cleaning liquid flows downwards and is in contact with the rolling brush 20, the cleaning liquid flushes the surface of the rolling brush 20, which facilitates flushing off the garbage and the sewage on the surface of the rolling brush 20.

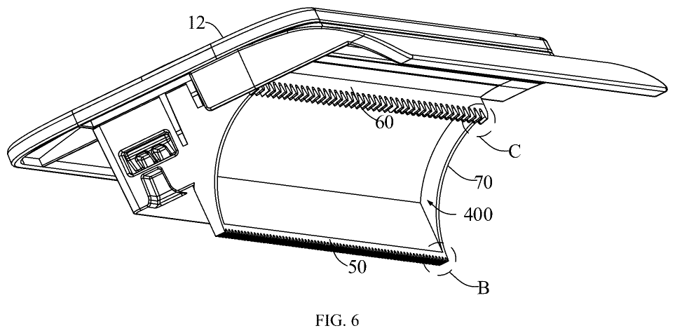

In some embodiments, referring to FIGS. 3 and 6, the housing 10 includes the base 11 and the upper cover 12 detachably covering the base 11. The upper cover 12 and the base 11 cooperatively define the dirt suction cavity 10a. A second baffle plate 50 is positioned in the dirt suction cavity 10a. The second baffle plate 50 and the rolling brush 20 are arranged side by side. An end of the second baffle plate 50 is connected with a surface of the upper cover 12 facing the rolling brush 20. The position where the second baffle plate 50 is connected to the upper cover 12 is located on a side of the spraying device 30 away from the first baffle plate 40 in the rotational direction of the rolling brush 20, and another side of the second baffle plate 50 extends toward the first baffle plate 40, so as to separate the rolling brush 20 from the spraying device 30, whereby a liquid outlet gap 200 is defined between the second baffle plate 50 and the first baffle plate 40. By these means, the second baffle plate 50 can act as a secondary insurance, which further prevents the garbage on the rolling brush 20 from being thrown onto the spraying device 30 and thus causing the spraying device 30 to become clogged.

It should be noted that the second baffle plate 50 and the upper cover 12 may be integrally formed with each other, the second baffle plate 50 and the upper cover 12 can be molded by injection molding through the same mold, which on the one hand reduces the number of parts of the entire cleaning equipment 100, and on the other hand ensures the strength of the connection between the second baffle plate 50 and the upper cover 12. The second baffle plate 50 and the upper cover 12 may also be positioned separately, and when the second baffle plate 50 and the upper cover 12 are positioned separately, the second baffle plate 50 and the upper cover 12 may be fixedly connected to each other by means of a screw connection, a snap connection, a weld, a glue bond, etc., in some embodiments, the second baffle plate 50 adopts a detachable connection means, such as a screw connection, a snap connection, etc., which allows the second baffle plate 50 to be replaced as a component.

The mounting wall 1111 is extending in the up and down direction, the opening of the mounting groove 1112 is arranged in the horizontal direction. The second baffle plate 50 may also be extending in the up and down direction. The second baffle plate 50 is arranged spaced apart from or tangent to the side of the rolling brush 20 adjacent to the spraying device 30. The second baffle plate 50 covers the opening of the mounting groove 1112, which can separate the spraying device 30 from the rolling brush 20. In addition, the second baffle plate 50 may serve as a transition structure between the mounting wall 1111 and the surface of the upper cover 12 facing the rolling brush 20, which allows air within the dirt suction cavity 10a to flow more smoothly from the surface of the second baffle plate 50 facing the rolling brush 20 to the surface of the upper cover 12 facing the rolling brush 20.

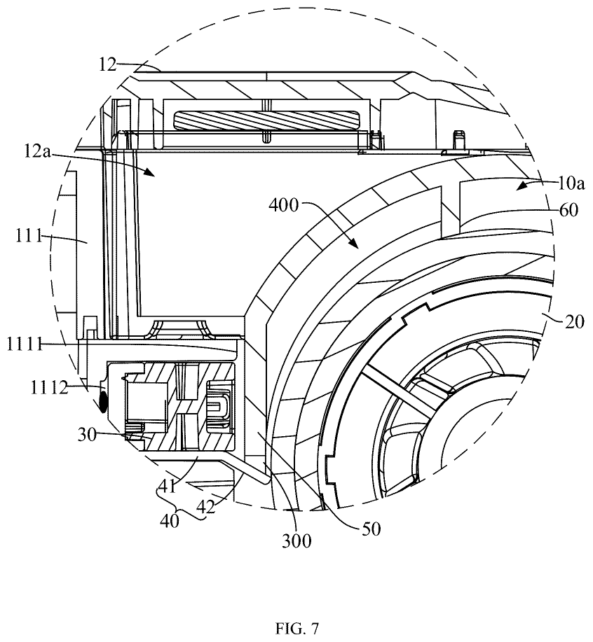

It should be noted that in the above embodiments the liquid sprayed by the spraying device 30 flows out from the liquid outlet gap 200 between the first baffle plate 40 and the second baffle plate 50. Referring to FIG. 7, in other embodiments of the present disclosure, the first baffle plate 40 and the second baffle plate 50 are connected to each other, and the first baffle plate 40 and/or the second baffle plate 50 define a liquid outlet 300. The liquid outlet 300 can be configured to allow the liquid sprayed by the spraying device 30 to flow out. The liquid outlet 300 may be formed by a hole structure on the first baffle plate 40 or the second baffle plate 50, and the liquid outlet 300 may also be formed by a hole structure formed by the enclosure of the first baffle plate 40 and the second baffle plate 50, which is not limited herein.

Referring to FIGS. 7 and 9, when the liquid outlet 300 is defined on the second baffle plate 50, the liquid outlet 300 is located at an end of the second baffle plate 50 adjacent to the first baffle plate 40, specifically, the end of the second baffle plate 50 adjacent to the first baffle plate 40 is concave to form a plurality of notches 51, the plurality of notches 51 are spaced apart in order along the axial direction of the rolling brush 20, and each notch 51 acts as a liquid outlet 300. By these means, the cleaning liquid sprayed from the spraying device 30 flows along the side of the first baffle plate 40 adjacent to the spraying device 30 to the rolling brush 20 through a plurality of liquid outlets 300.

Further, referring to FIG. 3, a third baffle plate 60 is positioned in the dirt suction cavity 10a, the third baffle plate 60 and the rolling brush 20 are arranged side by side, in other words, the third baffle plate 60 is extending along an axial direction of the rolling brush 20. The third baffle plate 60 is located on a side of the second baffle plate 50 away from the first baffle plate 40 in the rotational direction of the rolling brush 20. A side of the third baffle plate 60 is connected to the surface of the upper cover 12 facing the rolling brush 20, and another side of the third baffle plate 60 is in contact with the rolling brush 20. The second baffle plate 50, the third baffle plate 60, and the upper cover 12 cooperatively define a dirt storage space 400. The garbage on the rolling brush 20 is scraped off by the third baffle plate 60 and stored in the dirt storage space 400 between the second baffle plate 50 and the third baffle plate 60. When the dirt suction cavity 10a is needed to be cleaned, the upper cover 12 can be detached from the base 11 and then the garbage in the dirt storage space 400 can be cleaned out.

It should be noted that the third baffle plate 60 and the upper cover 12 may be integrally formed with each other, such that the third baffle plate 60 and the upper cover 12 are molded by the same mold, which on the one hand reduces the number of parts of the entire cleaning device 100, and on the other hand ensures the connection strength between the third baffle plate 60 and the upper cover 12. The third baffle plate 60 and the upper cover 12 may also be positioned separately, and when the third baffle plate 60 and the upper cover 12 are positioned separately, the third baffle plate 60 and the upper cover 12 may be fixedly connected to each other by means of screw connection, snap connection, welding, glue bond, etc. In some embodiments, the third baffle plate 60 adopts a removable connection means, such as screw connection, snap connection, etc., which allows the third baffle plate 60 to be replaced as a component.

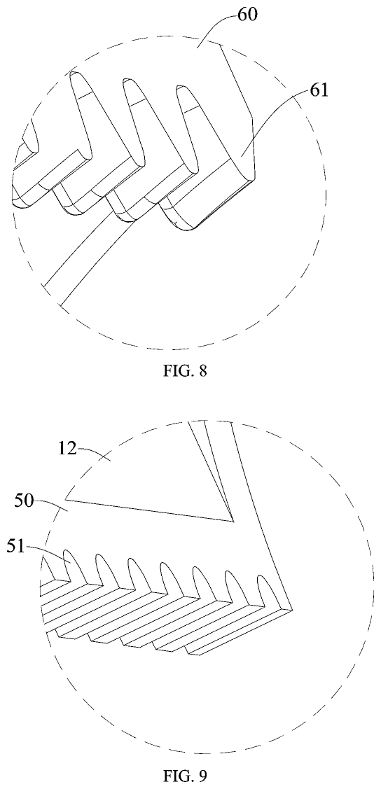

Further, referring to FIGS. 6 and 8, the third baffle plate 60 includes a plurality of comb teeth 61 on an end of the third baffle plate 60 away from the upper cover 12. The plurality of comb teeth 61 are sequentially arranged along the axial direction of the rolling brush 20. The plurality of comb teeth 61 can extend into the inside of the rolling brush 20 when the comb teeth 61 are in contact with the rolling brush 20, such that the garbage on the surface of the rolling brush 20 as well as in the inside of the rolling brush 20 can be cleaned. The garbage on the surface of the rolling brush 20 is cleaned once by the first baffle plate 40, the garbage that is more firmly adhered to the surface of the rolling brush 20 and hidden inside the rolling brush 20 can be cleaned out by the plurality of comb teeth 61 of the third baffle plate 60, such that the garbage on the rolling brush 20 is cleaned out and the rolling brush 20 can clean the floor better.

Further, the third baffle plate 60 extends in the upward and downward direction, and the end of the third baffle plate 60 away from the upper cover 12 is in contact with the highest position of the rolling brush 20. On the one hand, the probability that the garbage scraped off the rolling brush 20 by the third baffle plate 60 falls onto the rolling brush 20 again reduces, and on the other hand, it also ensures that the volume of the dirt storage space 400 is large enough, such that the frequency of cleaning the dirt storage space 400 can be controlled in an appropriate range, which is conducive to improving the user's experience.

Further, referring to FIGS. 3 and 6, two side baffle plates 70 are positioned in the dirt suction cavity 10a. The two side baffle plates 70 are arranged spaced apart in the axial direction of the rolling brush 20. The two side baffle plates 70 are connected to the upper cover 12. The two side baffle plates 70 are connected to the second baffle plate 50 and the third baffle plate 60, respectively. The two side baffle plates 70, the second baffle plate 50, and the third baffle plate 60 are arranged in an annular structure. The dirt storage space 400 is defined in the annular structure. The garbage in the dirt storage space 400 is simultaneously constrained by the second baffle plate 50, the third baffle plate 60, and the two side baffle plates 70, thereby preventing the garbage in the dirt storage space 400 from leaking out of the dirt storage space 400.

What described above are only the embodiments of the present disclosure, but are not intended to limit the scope of the present disclosure. It should be understood by those skilled in the art: they may still modify the technical solutions described in the foregoing embodiments, or make equivalent substitutions to some of the technical features thereof; such modification or substitution shall not separate the essence of the corresponding technical solution from the spirit and scope of the technical solution of each embodiment of the present disclosure.

What is claimed is:

1. A cleaning equipment, comprising a housing, a rolling brush, a spraying device, a dirt storage container, and a first baffle plate; wherein
a bottom portion of the housing defines a dirt suction cavity, the housing defines a dirt suction channel, the dirt suction channel comprises a dirt inlet opening and a dirt outlet opening, the dirt inlet opening is communicated with the dirt suction cavity, and the dirt outlet opening is communicated with the dirt storage container of the cleaning equipment;
the rolling brush is rotatably mounted in the dirt suction cavity and partially extends out of the dirt suction cavity, the spraying device is configured to spray cleaning liquid to the rolling brush, and the spraying device and the dirt inlet opening are arranged at intervals in a rotational direction of the rolling brush;
the first baffle plate is connected to a sidewall of the dirt suction cavity, the first baffle plate and the rolling brush are arranged side by side, the first baffle plate is positioned between the spraying device and the dirt inlet opening in the rotational direction of the rolling brush, and the first baffle plate is extending into the dirt suction cavity and configured to touch the rolling brush.

2. The cleaning equipment of claim 1, wherein the housing comprises a base and an upper cover, the base comprises a main body and two connecting arms, the two connecting arms are both connected to a side of the main body in a horizontal direction, the two connecting arms extend in the horizontal direction and arranged at intervals, the upper cover is connected to the main body and/or the two connecting arms, the upper cover, the main body and the two connecting arms cooperatively define the dirt suction cavity;
the rolling brush is positioned between the two connecting arms, two ends of the rolling brush in an axial direction of the rolling brush are rotatably connected to the two connecting arms respectively, the dirt suction channel is defined in the main body, the dirt inlet opening is defined in the side of the main body adjacent to the two connecting arms, the spraying device is connected to the main body and/or the upper cover, and the first baffle plate is connected to the main body and/or the upper cover.

3. The cleaning equipment of claim 2, wherein the main body comprises a mounting wall facing the rolling brush, the dirt inlet opening is defined in the mounting wall, the mounting wall defines a mounting groove, the mounting groove is located above the dirt inlet opening, and the spraying device is mounted in the mounting groove;
the first baffle plate comprises a connecting portion and a scraping portion, the connecting portion is positioned in the mounting groove, the connecting portion is positioned between the spraying device and a sidewall of the mounting groove adjacent to the dirt inlet opening, the scraping portion is connected to the connection portion and extends out of the mounting groove, and the scraping portion is configured to touch a circumferential surface of the rolling brush.

4. The cleaning equipment of claim 3, wherein the mounting wall is extending in an upward and downward direction, the scraping portion is extending in the axial direction of the rolling brush and is oblique with respective to the upward and downward direction, and a side of the scraping portion connecting with the connecting portion is higher than another side of the scraping portion touching the rolling brush.

5. The cleaning equipment of claim 3, wherein the connecting portion is made of a flexible material.

6. The cleaning equipment of claim 2, wherein the upper cover defines a liquid storage cavity, and the liquid storage cavity is communicated with the spraying device.

7. The cleaning equipment of claim 1, wherein the housing comprises a base and an upper cover detachably covering the base, the upper cover and the base cooperatively define the dirt suction cavity;
the cleaning equipment comprises a second baffle plate, the second baffle plate is positioned in the dirt suction cavity, the second baffle plate and the rolling brush are arranged side by side, an end of the second baffle plate is connected to a surface of the upper cover facing the rolling brush, a positioned where the second baffle plate is connected to the upper cover is located on a side of the spraying device away from the first baffle plate in the rotational direction of the rolling brush, another end of the second baffle plate extends toward the first baffle plate to separate the rolling brush from the spraying device, and a liquid outlet gap is defined between the second baffle plate and the first baffle plate.

8. The cleaning equipment of claim 7, wherein the second baffle plate and the upper cover is integrally formed with each other.

9. The cleaning equipment of claim 7, wherein the second baffle plate is arranged spaced apart from or tangent to a side of the rolling brush adjacent to the spraying device.

10. The cleaning equipment of claim 1, wherein the housing comprises a base and an upper cover detachably covering the base, the upper cover and the base cooperatively define the dirt suction cavity;
the cleaning equipment comprises a second baffle plate, the second baffle plate is positioned in the dirt suction cavity, the second baffle plate and the rolling brush are arranged side by side, an end of the second baffle plate is connected to a surface of the upper cover facing the rolling brush, a positioned where the second baffle plate is connected to the upper cover is located on a side of the spraying device away from the first baffle plate in the rotational direction of the rolling brush, another end of the second baffle plate extends toward the first baffle plate and is connected to the first baffle plate to separate the rolling brush from the spraying device, and the first baffle plate and/or the second baffle plate define liquid outlets.

11. The cleaning equipment of claim 10, wherein an end of the second baffle plate adjacent to the first baffle plate defines a plurality of notches, the plurality of notches are arranged spaced apart along an axial direction of the rolling brush, and each notch forms one liquid outlet.

12. The cleaning equipment of claim 7, wherein the mounting wall is extending in an upward and downward direction, the second baffle plate is extending in the upward and downward direction, and the second baffle plate covers an opening of the mounting groove.

13. The cleaning equipment of claim 7, further comprising a third baffle plate, the third baffle plate positioned in the dirt suction cavity, the third baffle plate and the rolling brush arranged side by side, the third baffle plate positioned on a side of the second baffle plate away from the first baffle plate in the rotational direction of the rolling brush, an end of the third baffle plate connected to the upper cover, another side of the third baffle plate touching the rolling brush, and the third baffle plate, the second baffle plate, and the upper cover cooperatively define a dirt storage space.

14. The cleaning equipment of claim 13, wherein the third baffle plate comprises a plurality of comb teeth, the comb teeth are positioned on the side of the third baffle plate touching the rolling brush, and the comb teeth are sequentially arranged along an axial direction of the rolling brush.

15. The cleaning equipment of claim 13, wherein the third baffle plate is extending in the upward and downward direction, and the third baffle plate is in contact with a highest position of the rolling brush in the upward and downward position.

16. The cleaning equipment of claim 13, further comprising two side baffle plates, the two side baffle plates positioned in the dirt suction cavity and arranged spaced apart in an axial direction of the rolling brush, the two side baffle plates connected with the upper cover, the two side baffle plates connected with the second baffle plate and the third baffle plate, the two side baffle plates, the second baffle plate, and the third baffle plate arranged in an annular structure, and the annular structure defines the dirt storage device.

17. The cleaning equipment of claim 13, wherein the third baffle plate and the upper cover is integrally formed with each other.

18. The cleaning equipment of claim 1, wherein a contour of the dirt suction cavity is a cylindrical shape.

19. A cleaning equipment, comprising:
a housing, a bottom portion of the housing defining a dirt suction cavity, the housing defining a dirt suction channel, the dirt suction channel comprising a dirt inlet opening and a dirt outlet opening, the dirt inlet opening communicated with the dirt suction cavity, a sidewall of the dirt suction cavity defining a mounting groove;
a dirt storage container communicated with the dirt outlet opening;
a rolling brush rotatably mounted in the dirt suction cavity and partially extends out of the dirt suction cavity, the spraying device and the dirt inlet opening arranged at intervals in a rotational direction of the rolling brush;
a spraying device positioned in the mounting groove and configured to spray cleaning liquid to the rolling brush; and
a first baffle plate connected to the sidewall of the dirt suction cavity, the first baffle plate and the rolling brush arranged side by side, the first baffle plate positioned between the spraying device and the dirt inlet opening in the rotational direction of the rolling brush, and the first baffle plate is configured to touch the rolling brush.

20. The cleaning equipment of claim 19, comprising a second baffle plate, the second baffle plate positioned in the dirt suction cavity, the second baffle plate and the rolling brush arranged side by side, an end of the second baffle plate connected to the sidewall of the dirt suction cavity, a positioned where the second baffle plate is connected to the sidewall of the dirt suction cavity located on a side of the spraying device away from the first baffle plate in the rotational direction of the rolling brush, and another end of the second baffle plate extends toward the first baffle plate to separate the rolling brush from the spraying device.
